(19) United States
(12) Patent Application Publication
(10) Pub. No.: US 2010/0037501 A1
(43) Pub. Date: Feb. 18, 2010

(54) CUSTOMIZED PERSONAL ITEM AND METHOD FOR IDENTIFICATION OF TRAITS AND PREFERENCES

(76) Inventor: Rosemarie Danielson, Farmington, MI (US)

Correspondence Address: DOBRUSIN & THENNISCH PC, 29 W LAWRENCE ST, SUITE 210, PONTIAC, MI, 48342, US

(21) Appl. No.: 12/537,491

(22) Filed: Aug. 7, 2009

Related U.S. Application Data
(60) Provisional application No. 61/088,365, filed on Aug. 13, 2008.

(51) Int. Cl. G09F 3/02

(52) U.S. Cl. 40/625

(57) ABSTRACT

A personal item and detachable identity items for attachment to a user or a user's belongings is disclosed The identity items serve to identify interests, dating status, personality traits, preferences, or other vital information about a user to anyone viewing the identity items. The personal item can be any accessory generally worn by a user or attached to a user's belongings. The identity items employ an attachment mechanism to allow for frequent and easy interchangeability of identity items. The method includes customizing the personal item and identity items to allow for maximum personal expression to serve as a means to provide information about a user to anyone viewing the personal item and identity items.

### CLAIM OF PRIORITY

The present application claims priority to U.S. Provisional Application No. 61/088,365, filed on Aug. 13, 2008, the contents of which are incorporated by reference for all purposes.

### FIELD OF THE INVENTION

This invention relates to a personal item in combination with one or more identity items used to simultaneously adorn and identify an individual's personal traits, characteristics or preferences and a method for providing a customization of the item and identifier. More particularly, one or more identity items are attached to a personal item wherein the identity items disclose information about a user to individuals viewing the identity items.

### BACKGROUND OF THE INVENTION

With the recent success and increased demand for accessories and personal items that can be customized to represent the taste and preferences of the user, there is a need for customizable personalized accessories that utilize a standard and commonly recognizable set of symbols and identifiers to convey characteristics, traits or personal preferences of individuals. By using a standardized set of identifiers, most individuals who view a set of identity items on a user will be able to immediately discern certain characteristics, traits or personal preferences of that user. The present invention serves the dual purpose of not only allowing individuals to customize and personalize a personal item or accessory, but also making use of one or more identity items containing symbols or icons selected from a standardized set of symbols or icons to reveal information about a user to anyone viewing the identity items.

U.S. Pat. No. 7,255,277 (Dragos, III) discloses a system and method to alert others of dating availability via a coded item. The method includes the use of an item such as a bracelet with different color coding to identify an individual's dating status and other personal preferences. The method includes a massive marketing campaign to make the public generally aware of the item and the preferences indicated by the various colors on the item.

U.S. Pat. No. 5,086,394 (Shapira) discloses personal devices that contain information about a user and can interact with one another to transmit that information to personal devices of other users. The devices contain electronic information about a user that includes traits and interests so that other individuals can approach an individual with preferred traits and interests. The system includes a control unit to facilitate the data transfer.

U.S. Pat. No. 7,254,962 (Scharr) discloses a jewelry system that allows for the interchanging of various elements of the jewelry, including interchangeable, beads, stones, and connectors.

Additional items of potential interest include U.S. Pat. No. 4,173,016 (Dickson), and U.S. Patent Application Publication Nos. 2005/0174975 (Mgrdechian) and 2006/0138727 (Khan).

These previous inventions fill the need for digital communication between personal devices and for identification of traits, but do not provide a standardized set of interchangeable items or symbols that is on display on a user and commonly understood by others. The present invention fulfills the need for both an item that is wearable and contains interchangeable or permanent items and/or digital information that expresses a user's individualism and personality traits and interests using a standardized set of symbols or identifiers.

### SUMMARY OF THE INVENTION

This invention relates to a personal item used to simultaneously adorn and identify a user's personality traits and interests via one or more identity items in contact with the personal item. The personal item and identity items are promoted in combination with a marketing plan that allows for the dissemination of a standardized set of symbols and identifiers so that anyone viewing the personal item will be able to identify a user's traits or interests. The standardized set of symbols and identifiers may also include symbols that are already commonly understood by the general public to be indicative of a specific trait or characteristic, with or without any associated marketing. The item employs a personal accessory such as a jewelry item, a piece of clothing or other accessory. The personal item will employ various attachment means that allow for the temporary or permanent attachment of interchangeable identity items.

In a first aspect, the present invention contemplates a method for personal identification comprising the steps of providing a personal item; providing one or more identity items for attachment to the personal item via an attachment mechanism; displaying the personal item and one or more identity items on or in contact with a user so that personal qualities or information relating to the user is conveyed to individuals viewing the one or more identity items.

This method may be further characterized by one or any combination of the following features; the personal item may be selected from the group consisting of a pin, a necklace, a charm, a watch, a wristband, a patch, a clip, a bracelet, a ring, an ID badge, a clothing item, a sticker, a temporary tattoo, a purse, a wallet, a shoe, a cell phone case, a backpack, a lunchbox, a briefcase or any combination thereof. The one or more identity items may be attached to the personal item via an attachment mechanism that may or may not permit interchangeability of various identity items, and-wherein the attachment mechanism is either magnetic, composed of a male part affixed to either the personal item or the identity items and a female part affixed to the opposing end, a friction-fit snap-in fastening means, a ridged or threaded opening and an opposingly ridged and threaded insert, a threaded screw mechanism, a flexible plural-prong clip and a cylindrical attachment site, an adhesive fastening means, or any combination thereof. The one or more identity items may be interchangeable with other identity items. The personal items and/or identity items may be customized at a retail point of sale by stamping, engraving, screen printing, or ink-jet or laser printing.

The one or more identity items may be attached to the personal item using a stamping process. The stamping process may comprise placing a color source in contact with a metal disc containing a raised imprint of an identity item so that the color source coats the metal disc; removing any excess color source that is not contained on the raised imprint of the identity item; contacting the raised imprint of the identity item with a stamping substrate so that at least a portion of the color source coats the stamping substrate; and contacting the stamping substrate with the personal item so that the identity item is printed onto the personal item.

The personal item or the one or more identity items may include an RFID tag for storing information about a user. The personal item and one or more identity items may be displayed and sold at a retail sale site and the personal item and the one or more identity items are attached to one another prior to sale and sold as one unit, wherein additional identity items may be purchased separately; or the personal item and the one or more identity items may be sold separately. The one or more identity items may be permanently affixed to the personal item.

The personal item and one or more identity items may be displayed and sold via an internet website wherein a selection of personal items and identity items are displayed and the identity items selected by a user are printed directly onto the personal item selected by the user. The personal item, the identity items or both may be digital in nature and capable of digitally transmitting information about a user to an individual capable of receiving the digital information. Security measures may be employed to allow transfer of the digital information about a user only to individuals selected by the user.

In a second aspect, the present invention contemplates a method for personal identification comprising the steps of providing a plurality of software modules that include: a personal item selector, a personal item materials selector; a personal item size selector; a personal item shape selector; a personal item color selector; an identity item selector; an identity item category selector; an identity item trait selector; an identity item materials selector; an identity item size selector, an identity item shape selector; wherein each of the plurality of modules communicates with one or more remaining modules so that incompatible combinations are not permitted; providing a user interface wherein a user or user representative provides order data via the plurality of software modules; compiling order data obtained from a user via the plurality of software modules; producing one or more personal items and one or more identity items based upon the order data; providing the one or more personal items and one or more identity items based upon the order data to the user or user representative.

This method may be further characterized by one or any combination of the following features: the one or more identity items may be interchargeable with other identity items, the one or more identity items may be permanently affixed to the personal item. The creation of the one or more personal items and one or more identity items based upon the order data may include the step of printing the one or more identity items directly onto the one or more personal items via a stamping process. The software may be available to users via a public website. The software may be available to retail establishments for use of the user or user representative within the retail establishment. The personal item and one or more identity items may be displayed and sold via an internet website wherein a selection of personal items and identity items are displayed and sold both together and separately.

In yet another aspect, the present invention contemplates a method for personal identification comprising the steps of providing a personal item, wherein the personal item can be attached to a user, a user's clothing or other personal belonging; attaching one or more identity items to the personal item, wherein the identity items include symbols and/or color codes that represent the user's dating status, social interests, traits, or any combination thereof; an attachment mechanism for attaching the identity items to the personal item wherein the attachment mechanism is magnetic, adhesive, includes printing the identity items directly onto the personal item, or any combination thereof; displaying the personal item and one or more identity items so that information about the user's dating status, social interests, traits, or any combination thereof is conveyed to anyone viewing the one or more identity items.

This method may be further characterized by one or any combination of the following features: the symbols and/or color codes may be disseminated via a marketing campaign so that the meaning of the symbols and/or color codes is known by individuals viewing the identity items. The identity items may also be attached to the personal item via a stamping process comprising: placing a color source in contact with a metal disc containing a raised imprint of an identity item so that the color source coats the metal disc, removing any excess color source that is not contained on the raised imprint of the identity item; contacting the raised imprint of the identity item with a stamping substrate so that at least a portion of the color source coats the stamping substrate; contacting the stamping substrate with the personal item so that the identity item is printed onto the personal item.

### BRIEF DESCRIPTION OF THE DRAWINGS

FIG. 1 is a view of one illustrative example of the invention.

FIG. 2 is a view of one example fastening means of the invention.

FIG. 3 is a view of one illustrative example of the invention.

FIG. 4 is a view of one illustrative attachment mechanism of an identity item.

FIG. 5 is an illustrative example of a personal item with multiple attachment mechanisms.

FIG. 6 is a view of an illustrative example of an attachment mechanism for an identity item.

FIG. 7 is an illustrative example of a point of purchase display for the identity items of the present invention.

FIG. 8 is a view of an illustrative example of a personal item of the present invention.

FIG. 9 is a view of an illustrative example of a personal item of the present invention.

FIG. 10 is a view of an illustrative example of a personal item of the present invention.

FIG. 11 is a view of an illustrative example of a personal item of the present invention.

FIG. 12 is a view of an illustrative example of a personal item of the present invention.

FIG. 13 is a view of an illustrative example of a personal item of the present invention.

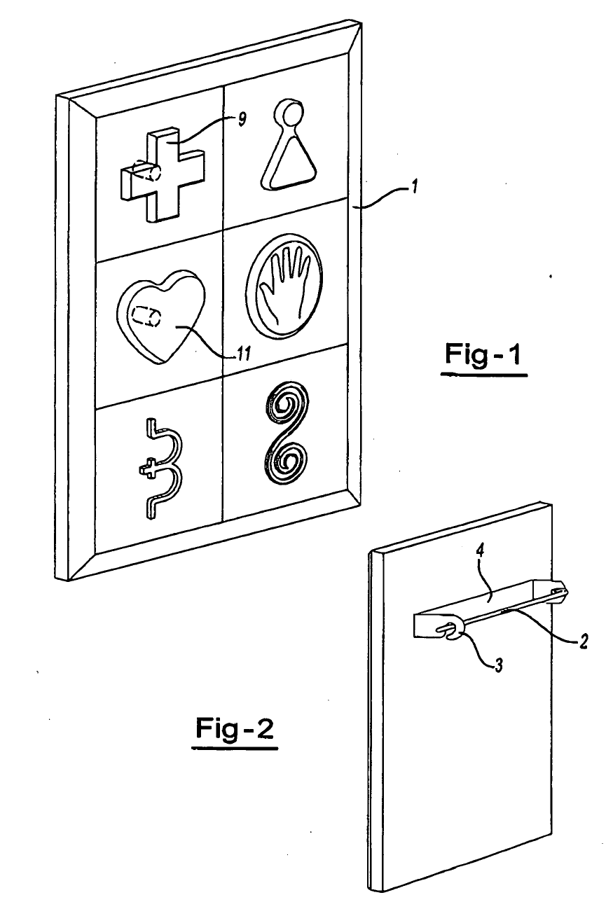

### DESCRIPTION OF THE PREFERRED EMBODIMENT

The invention employs a personal item 1 in the form of a jewelry item, a clothing item, an accessory, any item that can be worn or attached to a user or a user's belongings, or any combination thereof. The personal item may be a pin, a bracelet, a necklace, a scarf, a clothing item, an ID tag or badge, a shoe (e.g., a sneaker, sandal or flip flop) or shoelace, a purse or wallet, a backpack, an mp3 player, a cellular phone or cellular phone case, sunglasses or any other similar item. The personal item may also be a tie, gloves, a wristband, hair accessories, a hat or the like. The personal item may also be in the form of a temporary tattoo. In one preferred embodiment, the personal item is a pin or button that can be attached to a user's clothing or any other personal belonging such as a purse, a shoe or the like. The personal item can be any size so long as it allows for convenient attachment to a user or a user's belongings. The size of the personal item may also be adjustable to allow for attachment to different locations on a user or user's belongings.

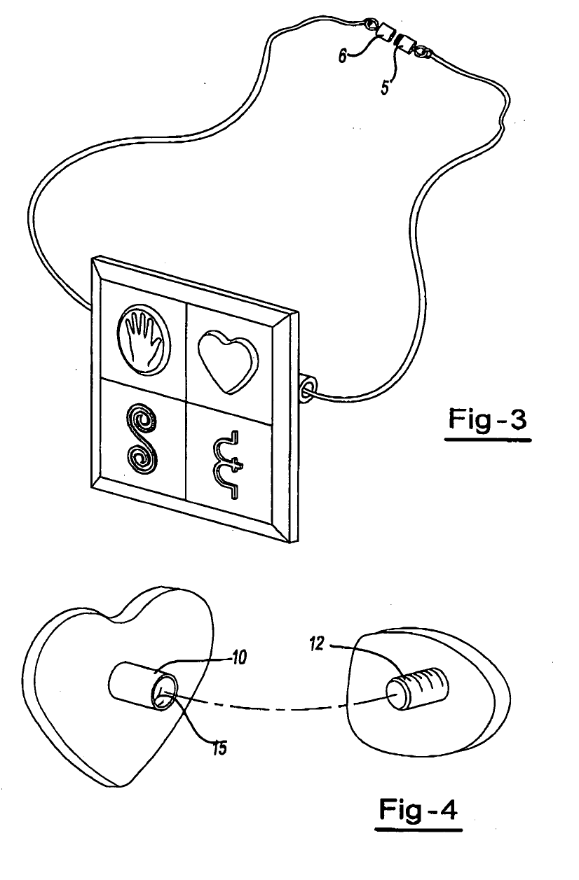

Preferably, the personal item may be flat, round or an alternative homogeneous or non-homogenous shape. The personal item may also be in the form of a temporary tattoo that originates on a substrate that contains the tattoo prior to application of the tattoo. The surface of the personal item need not necessarily be flat, but rather may be any shape so long as the identity items can be securely attached via an attachment mechanism. The personal item may be a wristband that is either rigid or flexible. The wristband may be designed so that additional parts or items can be slidably engaged with the wristband. The personal item may be composed of one type of material or may be composed of a combination of materials. In a preferred embodiment, the personal item can be one continuous portion of material or may be a number of portions combined. The personal item can be attached to the user or the user's belongings via any traditional method. For example, a necklace may use a clasp for attachment to a user, a backpack is attached to a user via straps. As shown, for example, in FIG. 2, the personal item may be a pin that can be attached to a user or a user's belongings via a thin rigid extension 2 attached to the back of a pin and a corresponding hook portion 3 that holds the metal extension in place thereby attaching the pin to a desired site. The hook portion and extension may be part of a clasp portion 4 that prevents the metal extension portion from dislodging. As shown, for example, in FIG. 3, the personal item may include a clasping means with one male 5 and one female 6 portion.

The personal item may also contain a mechanism to allow for differing methods of attachment to a user depending on where the personal item is to be attached. A user may prefer to attach the personal item as a pin one day and onto a cellular phone the next day. The personal item can be constructed of any number of materials including metal, plastic, natural fibers, rubber, foam or any combination thereof. Preferably, the personal item may be composed of plastic, formed by extrusion that is subsequently cut into uniform or non-uniform pieces.

The personal item contains one or more identity items 9 that can be removably attached to the personal item via one or more attachment mechanisms 10. In a preferred embodiment, the identity items will contain one or more symbols 11 and/or colors that are indicative of a user's personality traits, characteristics, interests and other information that may be of interest to those viewing the identity items, such as marital status and dating availability. The identity items may include a symbol, a charm, a tag, a jewel, a picture or any combination thereof. The color of an identity item may be indicative of a category such as, hobbies, jobs, or children and the design of the item itself designates a user's specific trait such as a hobby, their profession or whether or not they have children. As an example, a red space containing a heart may indicate that the user is single and interested in dating while an orange space containing a picture of a fork may indicate that the user enjoys cooking. An icon depicting a ruler may indicate that the user is employed in an education field, while the depiction of a cross may indicate that the user is catholic.

The personal item in conjunction with the one or more identity items may be of a digital and/or programmable nature where the personal item and/or identity items can contain and/or transmit the information about a user's personality traits, characteristics, interests and other information that may be of interest to those viewing the identity items. Such information may be programmed directly into the personal item and or identity items. Such information may also be entered into a computer or other storage device and subsequently uploaded or otherwise transmitted to the personal item or identity items. The digital information contained within a personal item or identity items may be transmitted to a similar device worn by another user. The digital information contained within the personal item or identity items may also include a link, profile number, or other indication of a website where further information about a user may be found. The standardized symbols and/or color code system may be utilized on current popular personal profile networks to identify traits, dating status, interests, preferences or moods of the user's. In another preferred embodiment, certain security measures may be instituted whereby a user can control who receives any digital information stored within the personal item or identity items and may also control who may view any further information located on a website.

The personal item and identity items may also include a bell mechanism, a programmable audible sound device, or tuned material so as to incorporate a desired sound as the identity items move and contact other identity items or the personal item itself. The identity items may also include a “mood” jewel, or a thermochromic material that can change color when exposed to different temperatures or different amounts of light. The personal item or the identity items may include an LED light to mike the items more visible in darker settings such as restaurants or bars. The personal item and/or the identity items may be constructed from recycled materials or made of materials that can later be recycled. The identity items may also be any combination of these or any similar items.

The identity items may be connected to the personal item via any suitable means. The method of attachment may allow for ease of interchargeability, inconspicuous attachment means, durability and/or security. The method of attachment may also facilitate permanent attachment such as via a printing or stamping process. The identity items may be fastened to the personal item such that they can be attached or detached while the personal item remains affixed to a user or user's belongings for ease of interchangeability of the identity items. The identity items are preferably securely attached to the personal item in order to prevent inadvertent loss of the identity items.

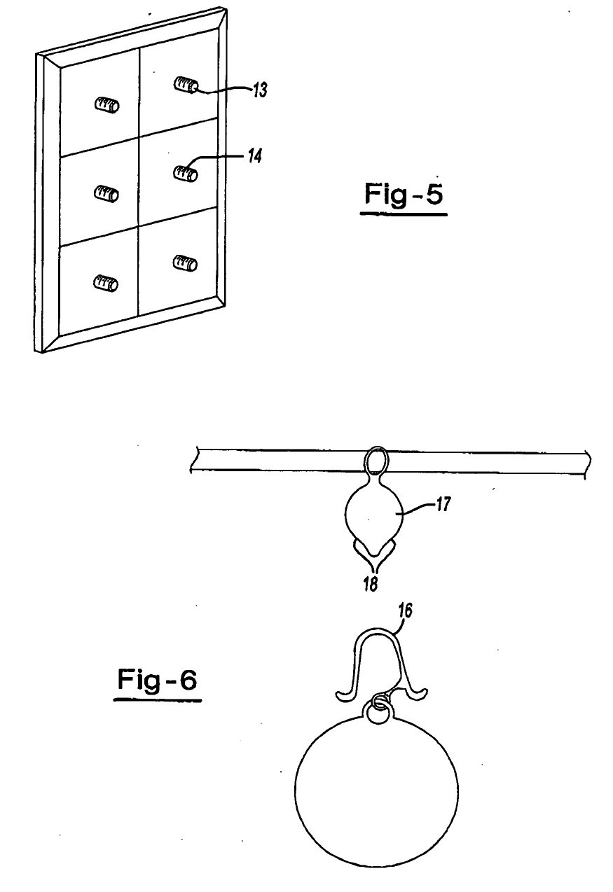

Any number of attachment mechanisms may be employed to facilitate attachment of the identity items to the personal item, including a magnet, an adhesive, or a male part affixed to either the personal item or the identity items and a female part affixed to the opposing end. As shown for example in FIG. 5, the identity items may also be attached via a circular or other shape protrusion 13 fastened to either the personal item or the identity items, which friction fits into a correspondingly shaped cavity within the opposing end requiring a predetermined tension to overcome the frictional force. The identity items may be shaped so that they may be slidably engaged with the personal item. For example a wristband may be shaped so that the identity items can be attached to or removed from the wristband while the wristband is being worn by a user. The identity items may be shaped so that they slide onto the wristband or other personal item from a location adjacent to the wristband or other personal item. The identity items may also be printed, stamped, or engraved directly onto a personal item so that no further attachment mechanism is required.

The attachment mechanism can be formed of planar or tubular metal or plastic. As shown, for example, in FIG. 4 the personal item provides a ridged and/or threaded opening 15 and/or the identity item contains an opposingly ridged and/or threaded insert 12 that allows for inter-connection of the ridges or threads when the identity item insert is placed into the attachment site opening. The identity item can be removed by any action that disengages the inter-connected ridges. Attachment may also employ a hook and loop type fastener.

The attachment mechanism may also be composed of threaded screw mechanism, where the identity item is attached to a screw-type piece that can be inserted into a circular, threaded tube-shaped site attached to the personal device. As shown, for example, in FIG. 6, the identity items may be affixed with a flexible plural-prong clip 16 and the personal item affixed with an attachment site 17 having an opening 18 for insertion of the prongs, wherein the distance between the prongs is wider than the diameter of the conical attachment site. It will be appreciated from the depiction in FIG. 6 that the arms can be deformed relative to each other to close gap and keep the identity item secure. It may be possible that the attachment mechanism will twist upon itself, so that it can be opened and reclosed (e.g., it may have one or more helical twisted ends that can be brought together to keep the identity item secure). The attachment site may be fitted with multiple grooves designed to receive the prongs from the identity items, such that each prong has a terminating end containing a horizontal piece no larger than the radius of the cylindrical attachment site, pointing into the opposing prong to allow for secure attachment to the cylindrical attachment site.

As represented in FIG. 5, it is also possible that the attachment mechanism can be integrally formed on the personal item. For example, during blow molding or some other molding operation, a ring or some other appendage defining a aperture may be formed to project outwardly from a wall of the personal item so that the identity item can be attached to such appendage (e.g., by passing a portion of its associated structure through the aperture).

A stamping process may also be utilized to attach the identity items to the personal item. The stamping process may include placing a color source in contact with a metal disc (or any similar substantially rigid and planar substrate) containing a raised imprint of an identity item so that the color source (e.g. an ink, paint, nail polish or the like) coats the metal disc. The color may then be removed in any areas containing excess color source that is not contained on the raised imprint of the identity item. The raised imprint of the identity item may then contacted with a stamping substrate so that at least a portion of the color source coats the stamping substrate, such that shape of the color appearing on the stamping substrate is shaped liked the raised imprint of the metal disc. The stamping substrate may then be contacted with the personal item so that the identity item is printed onto the personal item.

The identity items may have a geometry so that they may be configured to attach to one another via an interlocking or similar mechanism. The geometry of the identity items may be irregular or may be consistent among each identity item. The periphery of the identity items may include one or more curved edges. The periphery of the identity items may include one or more straight edges. The identity items may include one or more edges that are parallel to one or more opposing edges. The identity items may include one or more edges that are not parallel to one or more opposing edges. The identity items may include one or more edges that are longer than one or more opposing edges. The identity items may include one or more edges that are shorter than one or more opposing edges. The identity items may include one or more edges that are angularly offset relative to one or more opposing edges by an angle of less than 90 degrees. The identity items may include one or more edges that are angularly offset relative to one or more opposing edges by an angle of more than 90 degrees.

The personal item and identity items can be designed to appeal to a particular age group or a particular customer type. The personal items and identity items for children may include items depicting cartoon characters or toy logos and will include items commonly worn or carried by children including sneakers, lunchboxes, backpacks or the like. An upscale personal item or identity items may be made of a precious metal and may include gemstones. A men's personal item may include items generally worn or carried by men, including a watch, a wallet, a keychain, a tie, or the like. The personal items and identity items aimed at a particular customer type may be displayed for purchase at stores that specialize in goods for a particular customer type. For example, personal items and identity items designed for children may be displayed for purchase at toy stores, while personal items and identity items designed specifically for women may be sold at makeup or lingerie shops. The personal items and identity items may be presented in a self-contained display in a designated section of a retail facility. Preferably the personal items and identity items may be displayed among other, similar accessories including sunglasses, key chains, jewelry or the like. The personal items and identity items may also be displayed at the check-out counter to attract impulse purchasers.

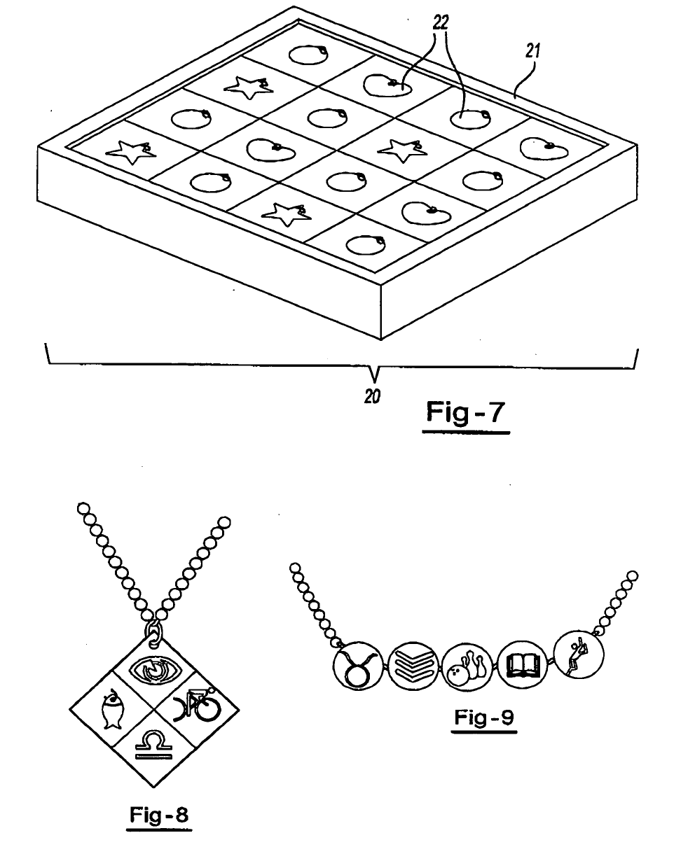

The identity items may be manufactured and sold with the personal item or separately to allow an individual to purchase one personal item and multiple identity items for ease and interest of interchangeability. As shown in FIG. 7, the personal items and identity items may be sold separately in a point-of-sale display 20, similar to a display for other personal accessories. The display system may be a flat, glass and/or plastic covered case, where each personal item and identity item is displayed separately. The display system may also incorporate a sensor that provides a signal to a cash register or sales person when a personal item or identity item is removed from the display, allowing purchasers easy access to the personal items and identity items, yet preventing theft that may occur with such small items.

The display system may be a flat or angled partitioned box 21, wherein each partition contains stock of one type identity item. The lid or multiple lids of the box may be translucent to allow a prospective purchaser to view how much stock, if any, exists for a given personal item or identity item. The lid or multiple lids of the box may also be opaque, requiring a prospective purchaser to open a partition of box to view the inventory. The box display may also include example drawings or actual identity items 22 attached to the lid of each partition to designate the type of personal item or identity item located within a particular partition.

The display system may be easily transportable within a given retail outlet or among a number of retail outlets. The display system may have an adhesive backing that allows for easy fixture to a wall or counter. The display system may contain a latch mechanism, possibly with a lock, to allow for secure, temporary or permanent attachment to a checkout counter, a rack, a wall, or the like.

The sale of the personal items and identity items may occur in conjunction with a marketing plan that disseminates to the public a standardized set of symbols and/or color coding that will be printed onto the identity items. Each symbol will have a corresponding meaning that will also be disseminated via the marketing plan. Some symbols may be indicative of a user's likes or dislikes, their profession, their astrological sign, their nationality, their marital status or the like. Those viewing the identity items can quickly and easily ascertain if a user is single and if the user has personality traits and interests that may be similar to the individual viewing the identity items. These universally understood symbols or color coding can be utilized on personal business cards, stationary, personal websites, cellular phones, or any other customizable medium. The identity items may also be digital in nature and may transmit to and from one user to another the marital status and interests of each user. The identity items may further include logos or other representations of corporate, educational or organizational interests.

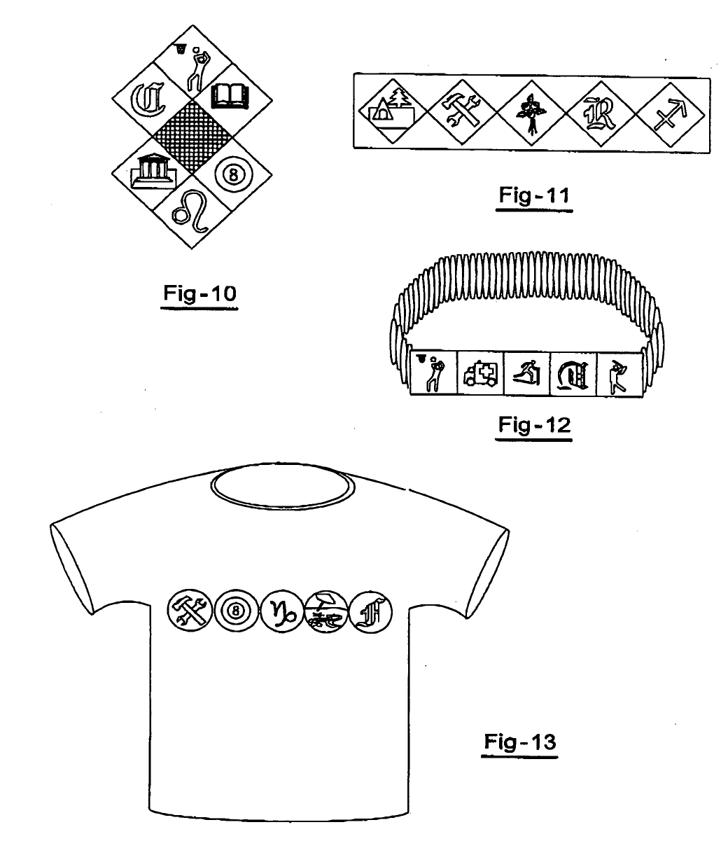

FIGS. 8-13 illustrate a number of examples of personal items and identity items attached to the various personal items. FIGS. 8 and 9 depict examples of personal items as necklaces with identity items attached in varying configurations. FIG. 10 depicts a personal item shown as a pin and containing a configuration of identity items. FIG. 11 shows the personal item as a wristband and FIG. 12 shows the personal item as a bracelet. FIG. 13 depicts the personal item as a shirt showing the identity items printed directly onto the shirt.

A user may also use a point-of-sale kiosk to purchase, choose, and design their own, unique, customized personal item and/or identity items. The point-of-sale kiosk may be located within a store or within a mall and may be capable of providing instant personal items and identity items. The point-of-sale kiosk may provide a finite number of choices for the type of personal item, the design of the personal item, the material and color of the personal item, the size and function of the personal item and the like. The point-of-sale kiosk may be equipped with a printing mechanism, such as an inkjet or laser printer or engraving means that allows for custom printing directly onto the personal item or identity items. The point-of-sale kiosk may be equipped with a stamping mechanism that also allows for custom printing directly onto the personal item or identity items. The point-of-sale kiosk may also be pre-filled with a pre-determined stock of certain personal items and identity items such that a user wishing to customize their product would be limited to what may be available within the kiosk at the time of sale.

The personal items and identity items may also be sold via in-home sales events, similar to those commonly employed for the sale of kitchen goods, candles, makeup and other goods. The in-home event may allow user's to purchase pre-designed personal items and identity items via a catalog. The in-home event may also allow users to purchase a custom personal item and identity items via a catalog. The in-home event may also allow users to design and produce personal items, identity items or both at the event.

The method of the present invention may also include a software program to aid in the design, ordering and production of the personal items and or identity items. The software program may include a plurality of modules and a user interface that presents the user with a number of selectors or options for the personal items and identity items. The selectors may include one or more of a personal item selector, a personal item materials selector, a personal item size selector, a personal item shape selector, a personal item color selector, an identity item selector, an identity item category selector, an identity item trait selector, an identity item materials selector, an identity item size selector, and an identity item shape selector. The plurality of modules may communicate with one or more remaining modules so that incompatible combinations are not permitted. A user or a representative of a user (e.g., a retail salesperson or other individual aiding in use of the software) may interact with the user interface by providing order data via the plurality of software modules. The software may then compile order data obtained via the plurality of software modules. The order data may then be used to produce one or more personal items and one or more identity items that can then be provided to the user. The software may be available to a user via the internet. The software may also be available at a retail location for direct use by a user or use by a user's representative.

The present invention may also allow for customizing a personal item and/or identity items via the internet. The steps may include displaying a home page and prompting a user to advance to one or more pages for selecting an item type, item size, item material, item color, fastener type, or any combination thereof. When a user selects “personal item type” they will be presented with a list of options that may include lapel pin, bracelet, watch, cell phone cover, t-shirt, hat or the like. This process will continue until all possible parameters of the custom personal item and identity items have been chosen. As a user is making the selections the web site may be visually displaying the selection, either as an individual feature, as part of an entire assembled personal item and identity items or both. In this manner, a customer may be able to view the intended product. Of course, the entire transaction, including payment, billing and shipping notices can be conducted over a secure site.

The methods herein also contemplate a process by which purchasers may recycle their identity items. Thus a retail establishment or internet website may offer for sale a previously-used identity item as one of its features.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention, should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. Other combinations and arrangements are also possible as will be gleaned from the following claims, which are also hereby incorporated by reference into the written description. The use of terms such as “first”, “second”, “a” or “an” does not preclude the presence of additional items.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

What is claimed is:

1. A method for personal identification comprising the steps of:
i. providing a personal item;
ii. providing one or more identity items for attachment to the personal item via an attachment mechanism;
iii. displaying the personal item and one or more identity items on or in contact with a user so that personal qualities or information relating to the user is conveyed to individuals viewing the one or more identity items.

2. The method of claim 1, wherein the personal item is selected from the group consisting of a pin, a necklace, a charm, a watch, a wristband, a patch, a clip, a bracelet, a ring, an ID badge, a clothing item, a sticker, a temporary tattoo, a purse, a wallet, a shoe, a cell phone case, a backpack, a lunchbox, a briefcase or any combination thereof.

3. The method of claim 1, further comprising placing the one or more identity items onto the personal item via a detachable fastening means that permits interchangeability of various identity items, and wherein the detachable fastening means is either magnetic, composed of a male part affixed to either the personal item or the identity items and a female part affixed to the opposing end, a friction-fit snap-in fastening means, a ridged or threaded opening and an opposingly ridged and threaded insert, a threaded screw mechanism, a flexible plural-prong clip and a cylindrical attachment site, an adhesive fastening means, or any combination thereof.

4. The method of claim 1, wherein the one or more identity items are interchangeable with other identity items.

5. The method of claim 1, further comprising a step of customizing the personal item or the one or more identity items at a retail point of sale by stamping, engraving, screen printing, or ink-jet printing.

6. The method of claim 1, wherein the one or more identity items are attached to the personal item using a stamping process.

7. The method of claim 6, wherein the stamping process comprises:
i. placing a color source in contact with a metal disc containing a raised imprint of an identity item so that the color source coats the metal disc;
ii. removing any excess color source that is not contained on the raised imprint of the identity item;
iii. contacting the raised imprint of the identity item with a stamping substrate so that at least a portion of the color source coats the stamping substrate;
iv. contacting the stamping substrate with the personal item so that the identity item is printed onto the personal item.

8. The method of claim 1, wherein the personal item and one or more identity items are displayed and sold at a retail sale site and:
i. the personal item and the one or more identity items are attached to one another prior to sale and sold as one unit, wherein additional identity items may be purchased separately; or
ii. the personal item and the one or more identity items are sold separately.

9. The method of claim 1, wherein the one or more identity items are permanently attached to the personal item.

10. The method of claim 1, wherein the personal item and one or more identity items are displayed and sold via an internet website wherein a selection of personal items and identity items are displayed and the identity items selected by a user are printed directly onto the personal item selected by the user.

11. The method of claim 1, wherein the personal item, the identity items or both are digital in nature and capable of digitally transmitting information about a user to an individual capable of receiving the digital information.

12. A method for personal identification comprising the steps of:
i. providing a plurality of software modules that include at least one of;
a. a personal item selector;
b. a personal item materials selector;
c. a personal item size selector;
d. a personal item shape selector;
e. a personal item color selector;
f. an identity item selector;
g. an identity item category selector;
h. an identity item trait selector;
i. an identity item materials selector;
j. an identity item size selector;
k. an identity item shape selector;
wherein each of the plurality of modules communicates with one or more remaining modules so that incompatible combinations are not permitted;
ii. providing a user interface wherein a user or user representative provides order data via the plurality of software modules;
iii. compiling order data obtained from a user via the plurality of software modules;
iv. producing one or more personal items and one or more identity items based upon the order data;
v. providing the one or more personal items and one or more identity items based upon the order data to the user or user representative.

13. The method of claim 12, wherein the one or more identity items are interchangeable with other identity items.

14. The method of claim 12, wherein the one or more identity items are permanently affixed to the personal item.

15. The method of claim 12, wherein producing the one or more personal items and one or more identity items based upon the order data includes the step of printing the one or more identity items directly onto the one or more personal items via a stamping process.

16. The method of claim 12, wherein the software is available to user's via a public website.

17. The method of claim 12, wherein the software is available to retail establishments for use of the user or user representative within the retail establishment.

18. A method for personal identification comprising the steps of:
i. providing a personal item, wherein the personal item can be attached to a user, a user's clothing or other personal belonging;
ii. attaching one or more identity items to the personal item, wherein the identity items include:
a. symbols and/or color codes that represent the user's dating status, social interests, traits, or any combination thereof;
b. a means that allows for attachment of the identity items to the personal item wherein the means is magnetic, adhesive, includes printing the identity items directly onto the personal item, or any combination thereof;
iii. displaying the personal item and one or more identity items so that information about the user's dating status, social interests, traits, or any combination thereof is conveyed to anyone viewing the one or more identity items.

19. The method of claim 18, wherein the symbols and/or color codes are disseminated via a marketing campaign so that the meaning of the symbols and/or color codes is known by individuals viewing the identity items.

20. The method of claim 18, wherein the identity items are attached to the personal item via a stamping process comprising:
i. placing a color source in contact with a metal disc containing a raised imprint of an identity item so that the color source coats the metal disc;
ii. removing any excess color source that is not contained on the raised imprint of the identity item;
iii. contacting the raised imprint of the identity item with a stamping substrate so that at least a portion of the color source coats the stamping substrate;
iv. contacting the stamping substrate with the personal item so that the identity item is printed onto the personal item.
